(19) United States
(12) Patent Application Publication
(10) Pub. No.: US 2016/0315641 A1
(43) Pub. Date: Oct. 27, 2016

(54) COMMON-MODE RIPPLE CORRECTION FOR HIGH-SPEED TRANSMITTERS

(71) Applicant: Broadcom Corporation, Irvine, CA (US)

(72) Inventor: Bharath Raghavan, Irvine, CA (US)

(21) Appl. No.: 14/715,862

(22) Filed: May 19, 2015

Related U.S. Application Data
(60) Provisional application No. 62/153,257, filed on Apr. 27, 2015.

(51) Int. Cl. H04B 1/04

(52) U.S. Cl. CPC H04B 1/0475; H04B 2215/069

(57) ABSTRACT

In some aspects, the disclosure is directed to methods and systems for common-mode ripple correction for high-speed transmitters. In one or more embodiments, the system includes a driver circuit of a complementary metal-oxide semiconductor (CMOS) transmitter. In one or more embodiments, the driver circuit has an output common-mode. In one or more embodiments, the system includes a predriver circuit with an output in electrical communication with an input of the driver circuit. In one or more embodiments, a comparator generates a control signal using a difference between an average signal value of the output common-mode and a target value. In one or more embodiments, the comparator block generates signals which can be used to adjust the strength of at least one of a pull-up path or a pull-down path in the predriver circuit.

### RELATED APPLICATIONS

This application claims priority to and the benefit of U.S. Provisional Patent Application No. 62/153,257, filed Apr. 27, 2015. The entire contents of the foregoing are hereby incorporated herein by reference for all purposes.

### FIELD OF THE DISCLOSURE

This disclosure generally relates to systems and methods of a transmitter, including but not limited to systems and methods for output common-mode adjustment of a serial link transmitter.

### BACKGROUND OF THE DISCLOSURE

In the last few decades, the market for communications devices has grown by orders of magnitude, fueled by the use of portable devices, and increased connectivity and data transfer between all manners of devices. Digital switching techniques have facilitated the large scale deployment of affordable, easy-to-use wireless and wired communication networks. Furthermore, digital and radio-frequency circuit fabrication improvements, as well as advances in circuit integration and other aspects have made communications equipment smaller, cheaper, and more reliable. As increased data rates, changes in fabrication process and other developments occur, new techniques and new standards are constantly being developed for adoption.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram depicting an embodiment of a network environment including one or more wireless communication devices in communication with one or more devices or stations;

FIGS. 1B and 1C are block diagrams depicting embodiments of computing devices useful in connection with the methods and systems described herein;

FIG. 2A is a diagram depicting one embodiment of a transmitter;

FIG. 2B is a diagram depicting an output for one embodiment of a driver with mismatched pull-up/pull-down strength;

FIG. 2C is a diagram depicting an embodiment of a system for output common-mode adjustment;

FIG. 2D is a diagram depicting an embodiment of a portion of a system for output common-mode adjustment;

FIG. 2E is a diagram depicting embodiments of a portion of a system for output common-mode adjustment; and

FIG. 2F is a diagram depicting another embodiment of a system for output common-mode adjustment; and

FIG. 2G is a flow diagram of an embodiment of a method for output common-mode adjustment.

The details of various embodiments of the methods and systems are set forth in the accompanying drawings and the description below.

### DETAILED DESCRIPTION

Although this disclosure can reference aspects of various standard(s) and specification(s), the disclosure is in no way limited to these aspects.

For purposes of reading the description of the various embodiments below, the following descriptions of the sections of the specification and their respective contents can be helpful:
Section A describes a network environment and computing environment which can be useful for practicing embodiments described herein; and
Section B describes embodiments of systems and methods for output common-mode adjustment.

### A. Computing and Network Environment

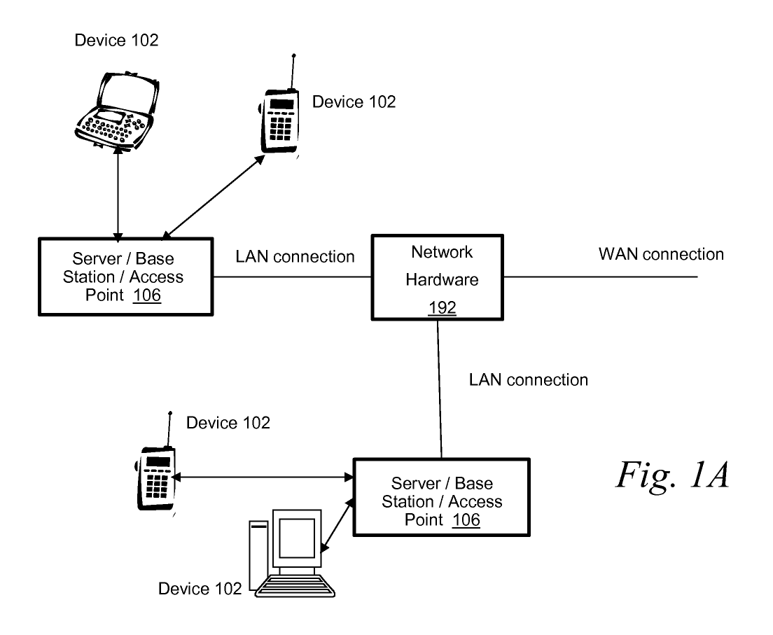

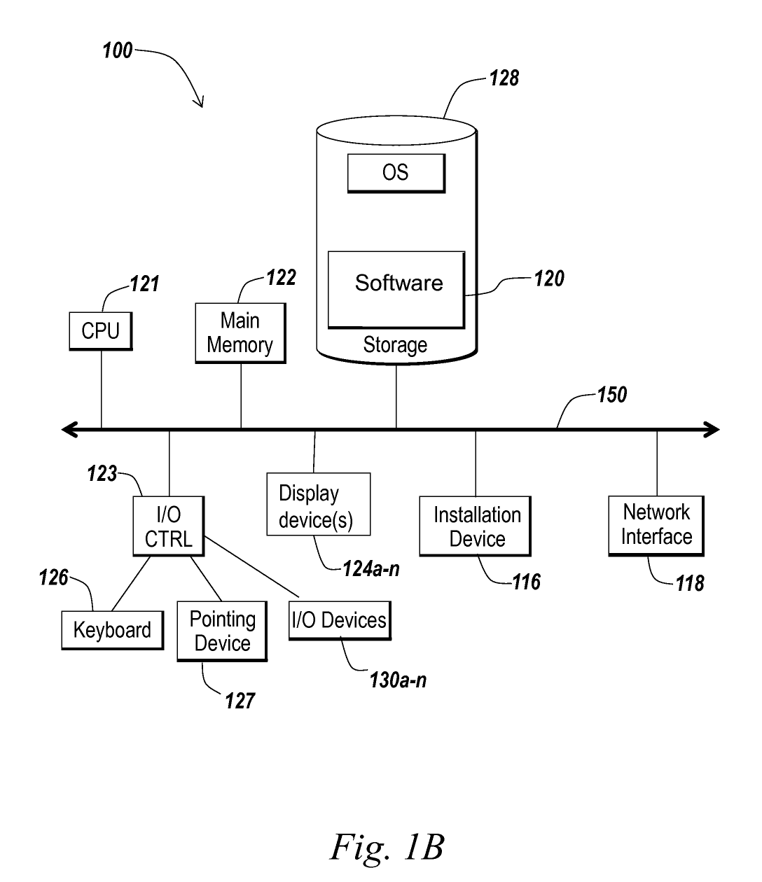

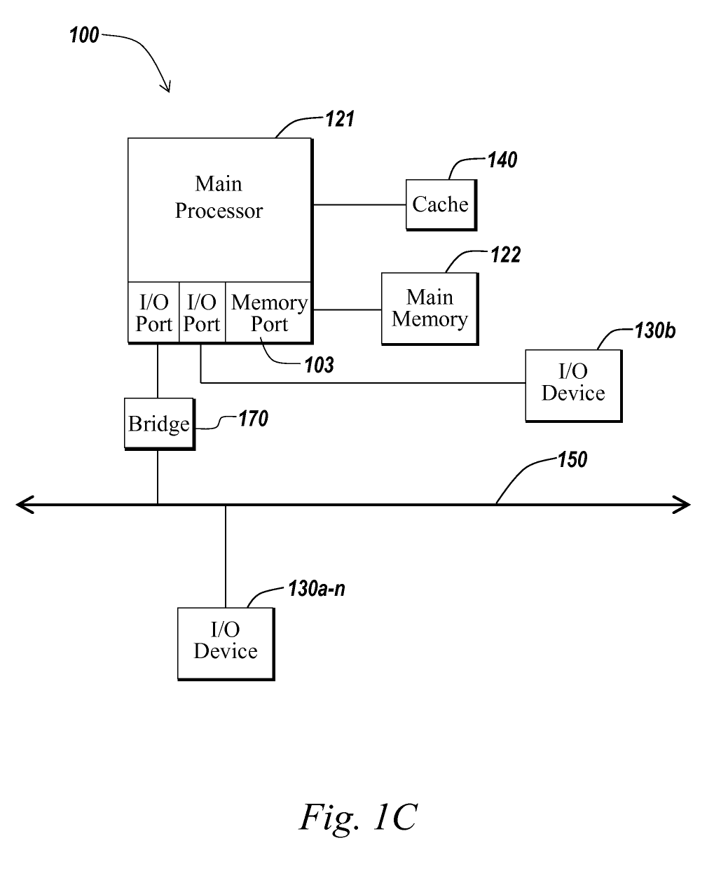

Prior to discussing specific embodiments of the present solution, it might be helpful to describe aspects of the operating environment as well as associated system components (e.g., hardware elements) in connection with the methods and systems described herein. Referring to FIG. 1A, an embodiment of a network environment is depicted. In brief overview, the network environment includes a communication system that includes one or more base stations 106, one or more wireless communication devices 102 and a network hardware component 192. The communication devices 102 can for example include laptop computers 102, tablets 102, personal computers 102 and/or cellular telephone devices 102. The details of an embodiment of each communication device and/or base station are described in greater detail with reference to FIGS. 1B and 1C. The network environment can be an ad hoc network environment, an infrastructure network environment, a subnet environment, etc., in one embodiment.

Terms such as “client device”, “communication device”, “user equipment,” “mobile station,” “mobile,” “mobile device,” “subscriber station,” “subscriber equipment,” “access terminal,” “terminal,” “handset,” and similar terminology, can refer to a device utilized by a subscriber or user of a communication service or network to receive or convey data, control, voice, video, sound, gaming, or substantially any data-stream or signaling-stream. The foregoing terms can be utilized interchangeably in the present disclosure. Likewise, terms such as “server”, “access point (AP),” “wireless access point (WAP),” “base station,” “base transceiver station”, “Node B.” “evolved Node B (eNode B or eNB),” home Node B (HNB),” “home access point (HAP),” and similar terminology, can be utilized interchangeably in the present disclosure, and refer to a network component or apparatus that serves and receives data, control, voice, video, sound, gaming, or substantially any data-stream or signaling-stream from a set of client devices.

Referring again to FIG. 1A, the server 106 can be operably coupled to the network hardware 192 via local area network connections. The network hardware 192, which can include a router, gateway, switch, bridge, modem, system controller, appliance, etc., can provide a local area network connection for the communication system. The communication devices 102 can register with a particular server 106 to receive services from the communication system. For direct connections (e.g., point-to-point communications), some communication devices 102 can communicate directly via an allocated channel and/or communications protocol. Some of the communication devices 102 can be mobile or relatively static with respect to the server 106.

In some embodiments, a server 106 includes a device or module (including a combination of hardware and software) that allows communication devices 102 to connect to a wired network using LTE, Wi-Fi, and/or other standards. A server 106 can be implemented, designed and/or built for operating in a local area network (LAN). A server 106 can connect to a router (e.g., via a wired network) as a standalone device in some embodiments. In other embodiments, a server 106 can be a component of a router. A server 106 can provide multiple devices 102 access to a network. A server 106 can, for example, connect to a wired Ethernet connection and provide wireless connections using radio frequency links for other devices 102 to utilize that wired connection. A server 106 can be built and/or implemented to support a standard for sending and receiving data using one or more communications protocols. A server 106 can be implemented and/or used to support public Internet hotspots, and/or on an internal network to extend the network's range.

In some embodiments, the servers 106 can be used for (e.g., in-home or in-building) networks (e.g., Ethernet networks). Each of the communication devices 102 and/or servers 106 can operate in accordance with the various aspects of the disclosure as presented herein to enhance performance, reduce costs and/or size, and/or enhance broadband applications. Each communication devices 102 can have the capacity to function as a client node seeking access to resources (e.g., data, and connection to networked nodes) via one or more servers 106.

The network connections can include any type and/or form of network and can include any of the following: a point-to-point network, a broadcast network, a telecommunications network, a data communication network, a computer network. The topology of the network can be a bus, star, or ring network topology. The network can be of any such network topology as known to those ordinarily skilled in the art capable of supporting the operations described herein. In some embodiments, different types of data can be transmitted via different protocols. In other embodiments, the same types of data can be transmitted via different protocols.

The communications device(s) 102 and server(s) 106 can be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the wireless communication devices 102 or the base station 106. As shown in FIGS. 1B and 1C, each computing device 100 includes a central processing unit 121, and a main memory unit 122. As shown in FIG. 1B, a computing device 100 can include a storage device 128, an installation device 116, a network interface 118, an I/O controller 123, display devices 124a-124n, a keyboard 126 and a pointing device 127, such as a mouse. The storage device 128 can include, without limitation, an operating system and/or software. As shown in FIG. 1C, each computing device 100 can also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by International Business Machines of White Plains, N.Y.; those manufactured by ARM Holdings, plc of Cambridge, England. or those manufactured by Advanced Micro Devices of Sunnyvale, Calif. The computing device 100 can be based on any of these processors, or any other processor capable of operating as described herein.

Main memory unit 122 can be one or more memory chips capable of storing data and allowing any storage location to be directly accessed by the microprocessor 121, such as any type or variant of Static random access memory (SRAM), Dynamic random access memory (DRAM), Ferroelectric RAM (FRAM), NAND Flash, NOR Flash and Solid State Drives (SSD). The main memory 122 can be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 can be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is provided by, for example, SRAM, BSRAM, or EDRAM. In the embodiment shown in FIG. 1C, the processor 121 communicates with various I/O devices 130 via a local system bus 150. Various buses can be used to connect the central processing unit 121 to any of the I/O devices 130, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 can use an Advanced Graphics Port (AGP) to communicate with the display 124. FIG. 1C depicts an embodiment of a computer 100 in which the main processor 121 can communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n can be present in the computing device 100. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices can be controlled by an I/O controller 123 as shown in FIG. 1B. The I/O controller can control one or more I/O devices such as a keyboard 126 and a pointing device 127, e.g., a mouse or optical pen. Furthermore, an I/O device can also provide storage and/or an installation medium 116 for the computing device 100. In still other embodiments, the computing device 100 can provide USB connections (not shown) to receive handheld USB storage devices such as the USB Flash Drive line of devices manufactured by Twintech Industry, Inc. of Los Alamitos, Calif.

Referring again to FIG. 1B, the computing device 100 can support any suitable installation device 116, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 100 can further include a storage device, such as one or more hard disk drives or redundant arrays of independent disks, for storing an operating system and other related software, and for storing application software programs such as any program or software 120 for implementing (e.g., built and/or designed for) the systems and methods described herein. Optionally, any of the installation devices 116 could also be used as the storage device. Additionally, the operating system and the software can be run from a bootable medium.

Furthermore, the computing device 100 can include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax, LTE, LTE-A and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 can include a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 can include or be connected to one or more display devices 124a-124n. As such, any of the I/O devices 130a-130n and/or the I/O controller 123 can include any type and/or form of suitable hardware, software, or combination of hardware and software to support, enable or provide for the connection and use of the display device(s) 124a-124n by the computing device 100. For example, the computing device 100 can include any type and/or form of video adapter, video card, driver, and/or library to interface, communicate, connect or otherwise use the display device(s) 124a-124n. In one embodiment, a video adapter can include multiple connectors to interface to the display device(s) 124a-124n. In other embodiments, the computing device 100 can include multiple video adapters, with each video adapter connected to the display device(s) 124a-124n. In some embodiments, any portion of the operating system of the computing device 100 can be implemented for using multiple displays 124a-124n. One ordinarily skilled in the art will recognize and appreciate the various ways and embodiments that a computing device 100 can be implemented to have one or more display devices 124a-124n.

In further embodiments, an I/O device 130 can be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 100 of the sort depicted in FIGS. 1B and 1C can operate under the control of an operating system, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein.

In some embodiments, the computing device 100 can have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Aspects of the operating environments and components described above will become apparent in the context of the systems and methods disclosed herein.

### B. Output Common-Mode Adjustment

Described herein are systems and methods for correcting, adjusting or reducing common-mode ripple for transmitters such as high speed transmitters. In one or more embodiments, the present systems and methods are used or deployed in a serial link, such as a high speed serial link. In one or more embodiments, the present systems and methods use feedback (e.g., via a feedback or control loop) to control device performance in a transmitter. For instance, and in one or more embodiments, the present systems and methods use a comparator at an output of the transmitter to generate a control signal. In one or more embodiments, the control signal is based on a deviation of output common-mode average from a target output. In one or more embodiments, the comparator feeds or directs the control signal to a predriver of the driver stage of the transmitter to control or adjust relative pull-up and pull-down strengths in the predriver. In one or more embodiments, this adjustment balances the single-ended output eye, which minimizes deviation of the average transmitter output common-mode from a target output.

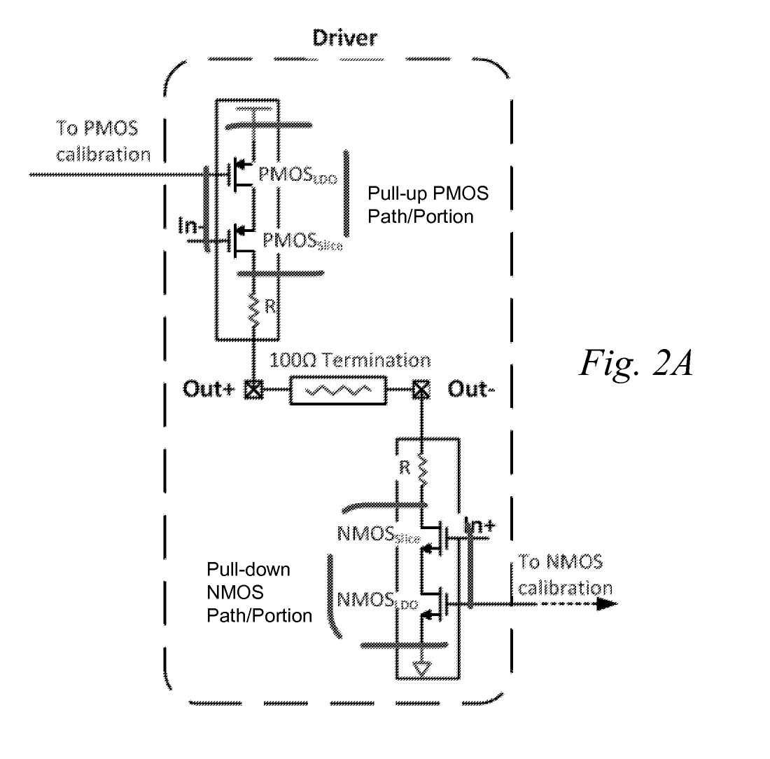

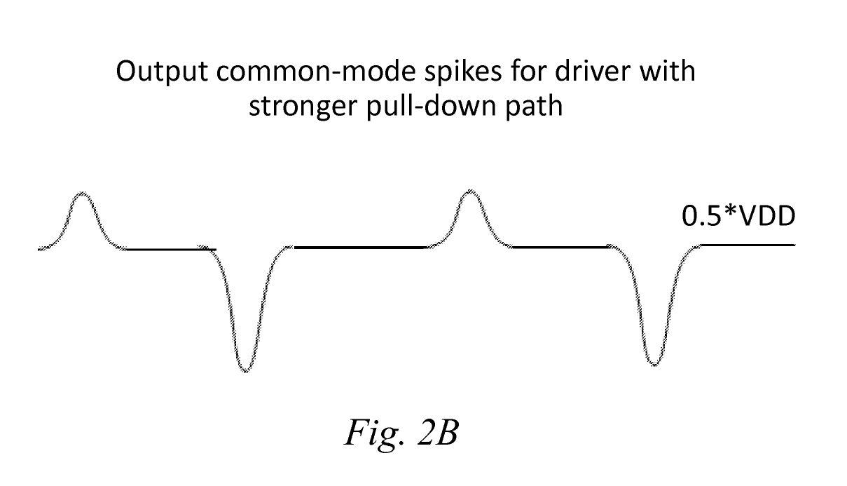

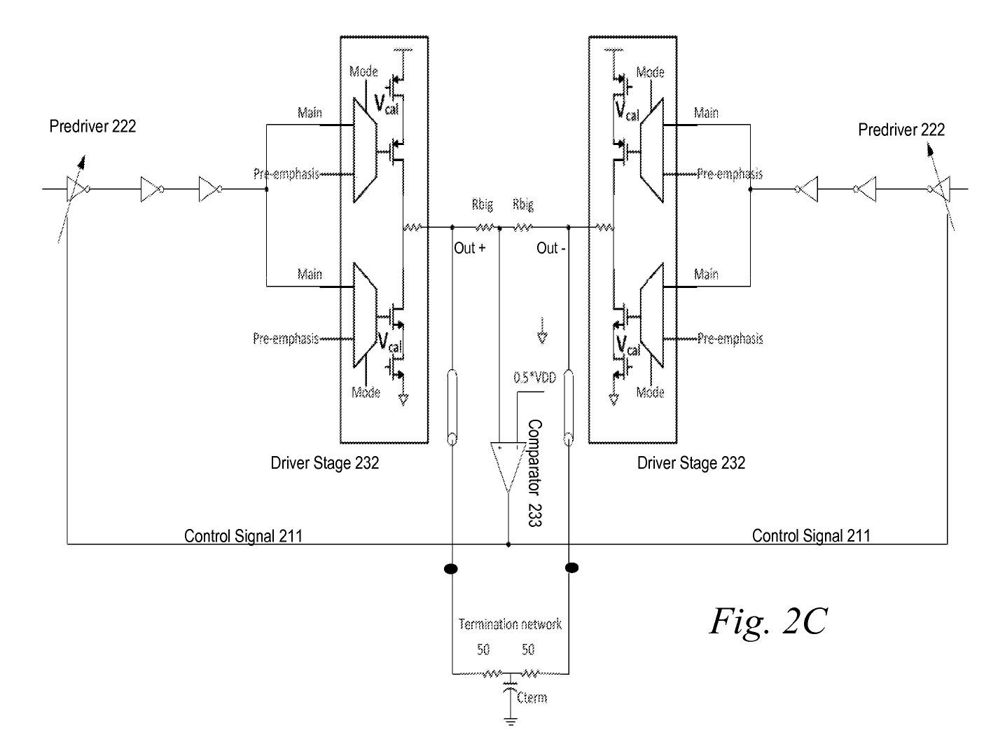

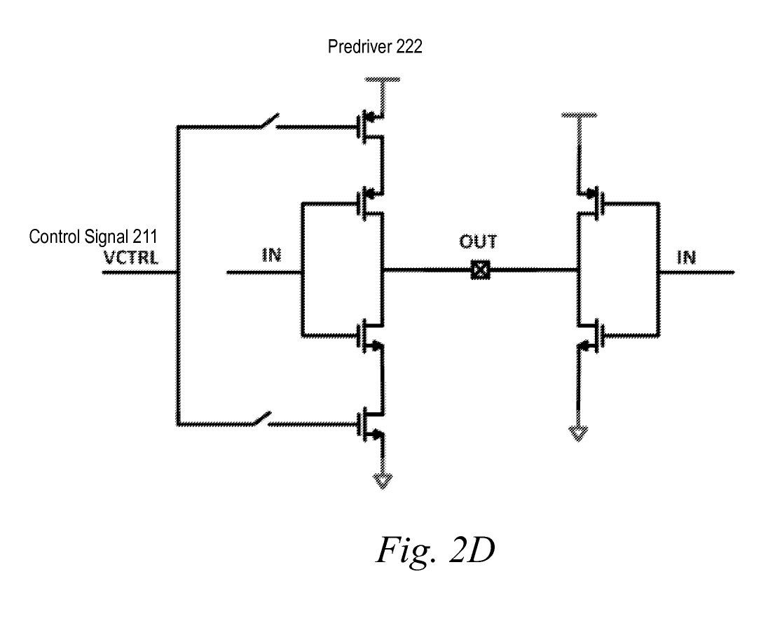

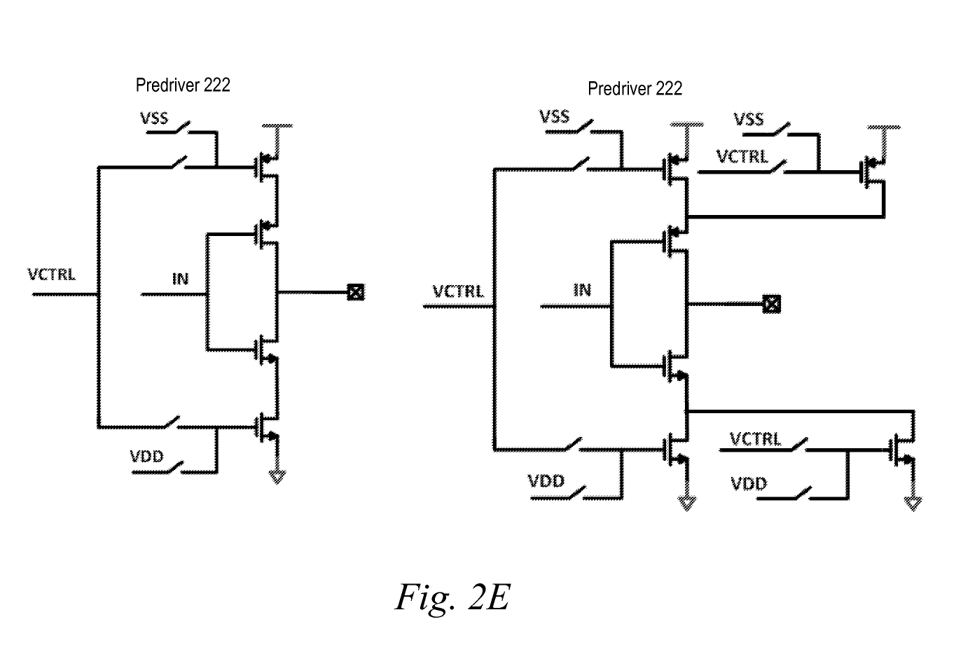

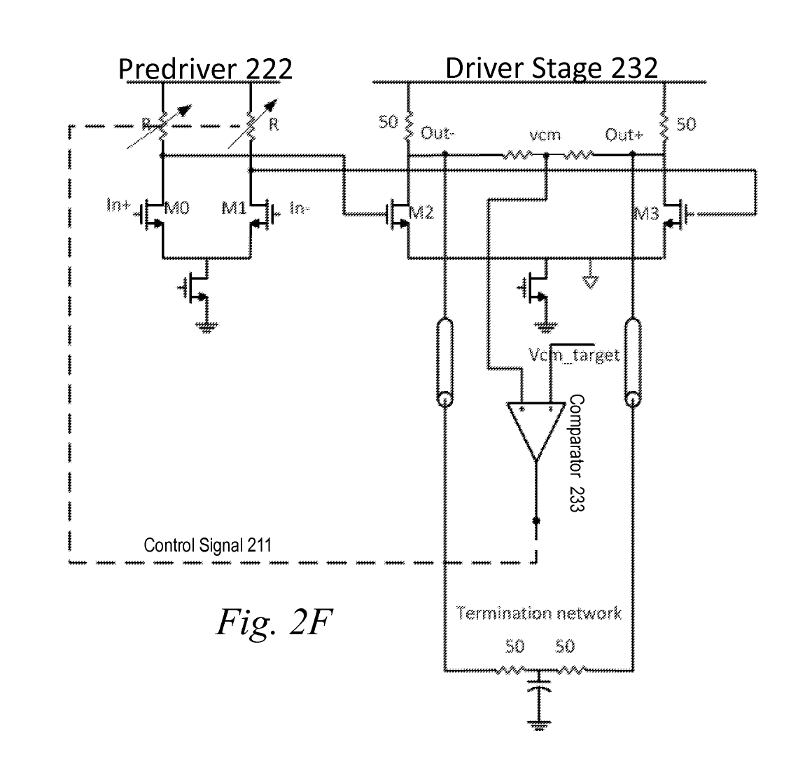

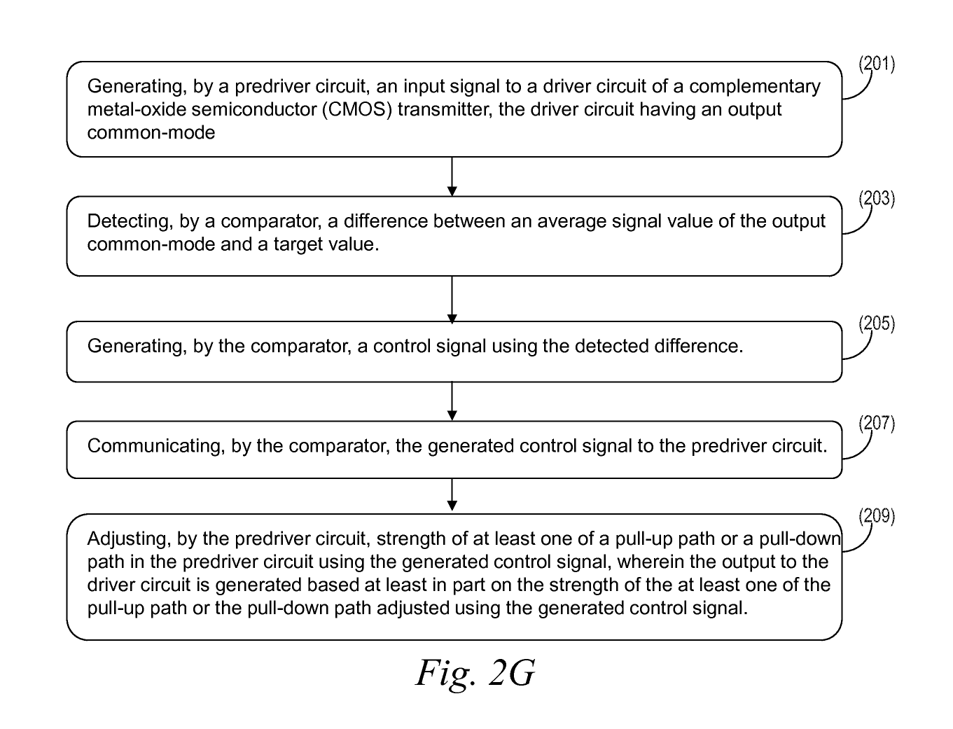

In some embodiments, high-speed drivers are increasingly being implemented using voltage-mode transmitters to achieve low power. In some embodiments, the ultra-low threshold devices of recent deep submicron devices (e.g., at the 20 nm process node), such as those implemented in a driver stage of a transmitter, show more mismatch in pull-up/pull-down strength than in previous complementary metal-oxide semiconductor (CMOS) processes. In some embodiments, this can result in an imbalanced single-ended output eye at an output of the transmitter, that is skewed towards a dominant (pull-up or pull-down) signal path. For instance, FIG. 2A depicts one embodiment of a transmitter, and FIG. 2B depicts one embodiment of an output for a driver with a stronger pull-down path. In one or more embodiments, the transmitter includes a voltage mode driver output stage. The voltage mode driver output stage includes a pull-up P-type metal-oxide semiconductor (PMOS) path, and a pull-down N-type metal-oxide semiconductor (NMOS) path, in one or more embodiments. Advanced processes (e.g., 28 nm, 20 nm, 16 nm, and smaller process nodes) provide extremely low-threshold voltage NMOS and PMOS devices for power/speed optimization, but this results in a mismatch of pull-up/pulldown strength. Due to an imbalance in strength between a pull-up path and a pull-down path, the transmitter's output common mode introduces a mismatch in signal spikes (e.g., peaks or troughs) corresponding to the pull-up and pull-down paths, relative to a target output (e.g., 0.5*VDD), in one or more embodiments.

In one or more embodiments, such a mismatch of pull-up/pull-down strength results in a single-ended output eye which is skewed towards one-side as opposed to being centered, e.g., relative to the target output. Such imbalance or skew can cause a violation of electromagnetic interference (EMI) specifications on the magnitude of the output common-mode ripple, in one or more embodiments. For instance, some EMI specifications indicate a threshold for an average magnitude (e.g., root mean squared (rms) value) of the output common-mode ripple. An EMI specification specifies a value, for example 12 mV or 17 mV (or some other value), in one or more embodiments.

In some embodiments, impact of spikes on average common-mode level is lower in a transmitter operating at moderate data rates, such as 10 Gb/s or lower, as compared to a transmitter operating at a comparatively higher data rate (e.g., 20 Gb/s or higher). In high-speed applications, ultra-low threshold devices are sometimes incorporated into a transmitter in one or more embodiments. For example and in one or more embodiments, to produce a transmitter operating at data rates greater than 20 Gb/s, advanced processes (e.g. 20 nm) with ultra-low threshold devices are used for power efficient design for instance. In one or more embodiments, such high-speed or high-frequency switching exacerbates the skew or excess voltage deviation from a balanced (target) scenario, and contributes to the output rms value. In one or more embodiments, for example as an alternative to using ultra-low threshold devices, a corresponding receiver uses one or more large common-mode termination capacitors (e.g., greater than 10 pF) to handle the ripple. However, substantial device area savings (e.g., on a chip) can be achieved by avoiding the use of the termination capacitors, in one or more embodiments.

In one or more embodiments, the present systems and methods balance the single-ended output eye of a transmitter by adjusting signal slopes in a predriver to the driver stage. Thus, EMI issues at the transmitter output are addressed independent of the specifics of the receiver implementation, in one or more embodiments. For instance, this obviates the alternative of having a large receiver common-mode termination capacitor, which can result in receiver area savings, in one or more embodiments. In one or more embodiments, the underlying principle of signal slope compensation in the predriver is extendable to current-mode transmitters. In this disclosure, the predriver is sometimes referred to as a predriver circuit or predriver stage, while the driver stage is sometimes referred to as a driver circuit or driver.

In one aspect, this disclosure is directed to a system for output common-mode adjustment. In one or more embodiments, the system includes a driver circuit of a CMOS transmitter. In one or more embodiments, the driver circuit has an output common-mode. In one or more embodiments, the system includes a predriver circuit with an output in electrical communication with an input of the driver circuit. In one or more embodiments, a comparator generates a control signal using a difference between an average signal value of the output common-mode and a target value. In one or more embodiments, the comparator adjusts the strength of at least one of a pull-up path or a pull-down path in the predriver circuit using the generated control signal.

In one or more embodiments, the driver circuit includes a voltage-mode driver or a current mode driver. In one or more embodiments, the driver circuit has a pull-up path and a pull-down path that are mismatched in strength. In one or more embodiments, the average signal value of the output common-mode comprises a root mean square (rms) voltage value. In one or more embodiments, the driver circuit or the CMOS transmitter operates at at least 10 gigabits per second. In one or more embodiments, the control signal comprises an analog voltage signal. In one or more embodiments, the predriver circuit performs digital switching of at least one pull-up or pull-down device in the predriver circuit to adjust the strength of at least one of the pull-up path or the pull-down path in the predriver circuit. In one or more embodiments, the predriver circuit minimizes rms voltage at the output common-mode using the control signal.

In another aspect, this disclosure is directed to a method for output common-mode adjustment. In one or more embodiments, a predriver circuit generates an input signal to a driver circuit of a CMOS transmitter. In one or more embodiments, the driver circuit has an output common-mode. In one or more embodiments, a comparator generates a control signal using a difference between an average signal value of the output common-mode and a target value. In one or more embodiments, the predriver circuit adjusts the strength of the at least one of the pull-up path or the pull-down path in the predriver circuit using the generated control signal. In one or more embodiments, the driver circuit comprises a voltage-mode driver or a current mode driver. In one or more embodiments, the average signal value of the output common-mode comprises a root mean square (rms) voltage value. In one or more embodiments, the driver circuit operates at at least 10 gigabits per second. In one or more embodiments, the predriver circuit performs switching of at least one pull-up or pull-down device in the predriver circuit to adjust the strength of the at least one of the pull-up path or the pull-down path in the predriver circuit. In one or more embodiments, the predriver circuit minimizes rms voltage at the output common-mode using the control signal.

In yet another aspect, this disclosure is directed to a system for output common-mode adjustment. In one or more embodiments, the system includes a predriver comprising circuitry that generates an input signal to a driver circuit of a CMOS transmitter. In one or more embodiments, the driver circuit has an output common-mode. In one or more embodiments, the predriver circuitry receives a control signal indicative of a difference between an average signal value of the output common-mode and a target value. In one or more embodiments, the predriver circuitry adjusts the strength of the at least one of the pull-up path or the pull-down path in the predriver circuit using the received control signal. In one or more embodiments, the output to the driver circuit is generated based at least in part on the strength of the at least one of the pull-up path or the pull-down path adjusted using the received control signal.

In one or more embodiments, the driver circuit includes a voltage-mode driver or a current mode driver. In one or more embodiments, the average signal value of the output common-mode includes a rms voltage value. In one or more embodiments, the predriver circuit operates at at least 10 gigabits per second. In one or more embodiments, the predriver circuit performs switching of at least one pull-up or pull-down device in the predriver circuit to adjust the strength of the at least one of the pull-up path or the pull-down path in the predriver circuit. In one or more embodiments, the predriver circuit minimizes rms voltage at the output common-mode using the control signal.

Referring to FIG. 2C, one example embodiment of a system for output common-mode adjustment is depicted. In brief overview, the system includes a CMOS transmitter, which incorporates a plurality of driver stages 232, corresponding predrivers 222, and a comparator 233, in one or more embodiments. In one or more embodiments, a driver stage 232 includes NMOS and/or PMOS devices. In one or more embodiments, a predriver 222 provides an output signal for input to a driver stage 232. In one or more embodiments, this output signal is communicatively coupled to, and/or amplified for the driver stage 232, via one or more buffers and/or inverters for example. Each of the elements or entities described herein is implemented at least in part in hardware. In one or more embodiments, the hardware includes circuitry or device logic which include one or more of a NMOS device, PMOS device, resistor, switch, capacitor, multiplexer, inverter, buffer and/or comparator, for example.

In one or more embodiments, the transmitter or driver stage 232 includes an output voltage mode driver or a current mode driver. In one or more embodiments, the transmitter includes an output which is sometimes referred to as an output common-mode. In one or more embodiments, each driver stage 232 outputs to or drives the output common mode. In one or more embodiments, the driver stage 232 has a pull-up strength and a pull-down strength that are mismatched, for example as described above in connection with FIGS. 2A and 2B. In one or more embodiments, there is a specification, such as an EMI specification or predetermined threshold, associated with the output common mode, for example as described above in connection with FIGS. 2A and 2B. In one or more embodiments, there is more than one specification associated with the output common mode. For example different specifications specified for a plurality of data rate ranges within which the transmitter operates, in one or more embodiments. In one or more embodiments, the driver stage or the transmitter operates at at least 10 Gb/s (or 12 Gb/s, 15 Gb/s, 20 Gb/s or other data rates), such as in the range of 25-28 Gb/s.

In one or more embodiments, the system includes common-mode ripple correction circuitry, e.g., a feedback or control loop. In one or more embodiments, the system includes a comparator 233 in the common-mode ripple correction circuitry. In one or more embodiments, the comparator 233 is part of the feedback or control loop. In some embodiments, a significant portion of the common-mode ripple specification violation arises from deviation of output common-mode average from a target value (e.g., 0.5*VDD). In one or more embodiments, the common-mode ripple correction circuitry compares the output common-mode against the target value and includes a feedback loop to adjust the relative pull-up versus pull-down strengths in the predriver 222 using an generated analog control voltage. In one or more embodiments, the single-ended output eye becomes more balanced due to the feedback adjustment, thereby minimizing deviation of average output common-mode from the design target value.

In one or more embodiments, the comparator 233 processes signal values of the output common-mode. For example, the comparator 233 dynamically processes one or more signal values of the output common-mode to dynamically generate (e.g., in real time or near real time) one or more average values, in one or more embodiments. In one or more embodiments, the comparator 233 determines an average value for the output common-mode (e.g., a continuous-time waveform), which corresponds to an average of signals (e.g., waveform signals) over a period of time. In one or more embodiments, the average is a root mean squared or quadratic mean determination. In one or more embodiments, the average is a mean, for example a statistical or arithmetic mean, median, mode, average or central tendency. In one or more embodiments, the average is a moving average. In one or more embodiments, the average is a geometric, harmonic, cubic, weighted or other type of mean.

In one or more embodiments, the comparator 233 compares the average signal value of the output common-mode against a target or reference value (e.g., 0.5 VDD or other voltage value). In one or more embodiments, the comparator 233 includes a module for determining the average value, and a comparison module for comparing the average signal value against the target or reference value. In one or more embodiments, the comparator 233 outputs, generates or produces a control signal using or based on a difference between an average signal value of the output common-mode and a target value. In one or more embodiments, the comparator 233 provides or feedbacks the control signal to a predriver 222. In one or more embodiments, the control signal dynamically adjusts the output signal of the predriver 222 that is communicated to the driver stage 232. In one or more embodiments, the comparator 233 and/or predriver 222 adjusts or biases at least one of a pull-up strength and a pull-down strength in the predriver 222 using the generated control signal. In one or more embodiments, the control signal includes an analog voltage signal or some other type of signal. In one or more embodiments, the control signal adjusts the output signal of the predriver 222, e.g., a peak and/or slope (rising and/or falling slope) of the output signal.

By way of non-limiting example, FIG. 2D depicts one embodiment of a portion of a system for output common-mode adjustment. The portion includes an embodiment of the predriver 222 with pull-up and/or pull-down strength controllable by a control signal. The control signal is sometimes referred to as VCTRL, for example as shown in FIG. 2D. In one or more embodiments, one or more switches connects VCTRL to a pull-up path and/or a pull-down path circuitry, e.g., to adjust the strength of the pull-up and/or a pull-down paths of the predriver 222. Therefore, in one or more embodiments, the pull-up and/or a pull-down strength(s), or relative pull-up/pull=-down strength of a predriver 22 is controlled by means of an analog control signal VCTRL generated by the feedback loop.

In one or more embodiments, the control signal includes an instruction or digital signal to adjust the output signal of the predriver 222. An analog-to-digital converter converts at least a portion of the control signal to operate one or more switches, in one or more embodiments. In one or more embodiments, the predriver 222 circuit performs digital switching of at least one pull-up or pull-down device in the predriver 222 circuit to adjust the strength of at least one of the pull-up path or the pull-down path in the predriver 222 circuit. By way of non-limiting example, FIG. 2E depicts embodiments of a portion of a system for output common-mode adjustment. The left and right side of FIG. 2E each depicts a different embodiment of the predriver 222 with strength of the pull-up and/or pull-down paths controllable by a control signal and/or at least one switch. In one or more embodiments, one or more switches introduces one or more of a VCTRL, VSS and/or VDD level, to one or more portions of the predriver 222 to adjust the strength of the pull-up and/or a pull-down paths of the predriver 222. For example, by changing the number of PMOS and/or NMOS devices in a pull-up and/or a pull-down path via one or more switches, the strength of the pull-up and/or pull-down paths of the predriver 222 is modified. Separately or in combination, one or more pull-up and/or a pull-down paths of the predriver 222 is adjustable using the control signal or VCTRL, in one or more embodiments. Therefore, in one or more embodiments, the predriver 222 incorporates one or a combination of analog and digital approaches to dynamically configure pull-up/pull-down devices.

In one or more embodiments, the predriver 222 minimizes rms voltage at the output common-mode using the control signal. By pre-biasing signals provided by the predriver 222 to the corresponding driver stage 232, the control signal indirectly controls or adjusts the output common mode signals of the driver stage 232, in one or more embodiments. In one or more embodiments, the control signal indirectly compensates or adjusts for the mismatch in pull-up and pull-down strengths of the driver stage 232. In one or more embodiments, this compensation or pre-basing results in a reduced rms voltage at the output common-mode, as compared to a transmitter without the feedback loop.

In one or more embodiments, the transmitter is able to incorporate ultra-low threshold voltage devices in the driver design which results in power-optimal high-speed operation (e.g., 25-28 Gb/s). In one or more embodiments, the transmitter is able to meet a predetermined or pre-specified common-mode ripple requirement (e.g., <12 mV rms), for example without using a large termination common-mode capacitor (e.g., >10 pF) at the corresponding receiver. This results in area savings in the receiver implementation and adherence to EMI specifications at the transmitter, in one or more embodiments. By way of illustration, the common-mode ripple when using extra/ultra-low threshold voltage devices in 20 nm CMOS has been observed to be more than 30 mV rms, in one or more embodiments. However, a voltage-mode driver with a ripple-correction circuitry enabled as described herein, is able to reduce a rms voltage ripple of up to 50 mV rms, to a level below 10 mV. In one or more embodiments, the present systems and methods allow serial link products to satisfy vendor EMI requirements. In one or more embodiments, this becomes more important as higher data rates (e.g., >25 Gb/s) are achieved in CMOS-type voltage mode transmitters. The alternative of using older generation/higher threshold voltage devices is not practical for speed/power reasons. Also, the use of a large receiver termination capacitor is often impractical due to on-chip area constraints, and/or is not within the control of the transmitter's designer. It is noted that EMI concerns increase with the number of cores integrated onto a single die.

In one or more embodiments, the present systems and methods support a variety of transmitters, and are not restricted to voltage mode transmitters. Moreover, the principle underlying this scheme can be used to reduce any type of common-mode ripple. In one or more embodiments, the present systems and methods support current-mode logic by adjusting the relative pull-up/pull-down strengths of resistor/transistor respectively. For instance, some embodiments of the present systems and methods are applied to current mode drivers.

By way of illustration, FIG. 2F depicts an embodiment of a system for output common-mode adjustment. In one or more embodiments of this current mode form, a pull-up path in an NMOS-type current mode cell (e.g., predriver 222) is through a resistor while pull-down is through an NMOS device. The opposite is true of a PMOS-type current mode cell, in one or more embodiments. In one or more embodiments, the output common-mode level (e.g., vcm) is compared, via a comparator 233, against a target value (e.g., Vcm_target) to generate a control voltage. In one or more embodiments, the comparator 233 provides the control signal 211 to adjust the resistance of the current mode predriver 222. This adjustment is via analog control and/or performed digitally (e.g., with an intervening analog-to-digital converter to generate the digital controls), in one or more embodiments.

Referring now to FIG. 2G, one embodiment of a method for output common-mode adjustment is depicted. The method includes generating, by a predriver circuit, an input signal to a driver circuit of a CMOS transmitter (operation 201). The driver circuit has an output common-mode, in one or more embodiments. A comparator detects a difference between an average signal value of the output common-mode and a target value in one or more embodiments (operation 203). The comparator generates a control signal using the detected difference, in one or more embodiments (operation 205). The comparator communicates the generated control signal to the predriver circuit in one or more embodiments (operation 207). The predriver circuit adjusts strength of at least one of a pull-up path or a pull-down path in the predriver circuit using the generated control signal in one or more embodiments (operation 209). The driver circuit generates the output based at least in part on the strength of the at least one of the pull-up path or the pull-down path adjusted using the received control signal.

Referring now to operation 201, and in some embodiments, a predriver circuit generates an input signal to a driver circuit (or driver stage 232) of a CMOS transmitter. The driver circuit is sometimes referenced as the driver stage 232, and the predriver circuit is sometimes referenced as the predriver 222. The driver circuit has an output common-mode, in one or more embodiments. An output of the predriver circuit provides an output signal for input to the driver circuit, in one or more embodiments. In one or more embodiments, the predriver circuit generates the input signal using a signal (e.g., a modulated signal) from a signal source and/or based on information retrieved from storage. The predriver circuit generates the input signal based on one or more adjustment controls (e.g., control signal 211) that control the pull-up and/or pull-down strength of the predriver circuit, in one or more embodiments. The predriver circuit generates the input signal based on one or more adjustment controls that control the relative pull-up/pull-down strength of the predriver circuit, in one or more embodiments.

In one or more embodiments, the output of the predriver circuit is communicatively coupled to an input of the driver circuit. In one or more embodiments, the output of the predriver circuit is electrically and/or physically coupled to an input of the driver circuit. One or more amplifiers, buffers and/or inverters convey, repeat and/or amplify the output signal from the predriver circuit to the input of the driver circuit, in one or more embodiments.

In one or more embodiments, the driver circuit includes a voltage-mode driver or a current mode driver. In one or more embodiments, the driver circuit and/or the predriver circuit operate at at least 10 gigabits per second. In one or more embodiments, the driver circuit and/or the predriver circuit has a pull-up path and a pull-down path that are mismatched in strength.

Referring now to operation 203, and in some embodiments, a comparator 233 detects a difference between an average signal value of the output common-mode and a target value. The comparator 233 compares the output common-mode to the target value, in one or more embodiments, to detect the difference or deviation. The comparator 233 tracks, detects, calculates and/or determines a deviation of the output common-mode from the target value, in one or more embodiments. The comparator 233 tracks, detects, calculates and/or determines a deviation of an average signal value of the output common-mode from the target value, in one or more embodiments. In one or more embodiments, the comparator 233 dynamically determines this deviation or difference, e.g., in real time or near real time.

In one or more embodiments, the comparator 233 processes one or more signal values of the output common-mode. For example, the comparator 233 dynamically processes one or more signal values of the output common-mode to dynamically generate (e.g., in real time or near real time) one or more average values, in one or more embodiments. In one or more embodiments, the comparator 233 determines an average value for the output common-mode or output ripple (e.g., a continuous-time waveform). In one or more embodiments, the comparator 233 determines an average value which corresponds to an average of signals (e.g., of waveform signals) over a period of time. In one or more embodiments, the comparator 233 determines or calculates an average signal value of the output common-mode as a root mean square voltage value.

Referring now to operation 205, and in some embodiments, the comparator generates a control signal 211 using the detected difference. In one or more embodiments, the comparator 233 outputs, generates or produces the control signal 211 using or based on a difference between an average signal value of the output common-mode and a target value. In one or more embodiments, the comparator 233 operates at and/or receives an output (e.g., ripple output) of the transmitter to generate a control signal 211 or feedback signal. In one or more embodiments, the comparator receives and/or uses a target signal, voltage or level (e.g., 0.5 VDD). The comparator 233 generates or produces the control signal 211 as a function of the determined or detected difference or deviation, in one or more embodiments. For example, the comparator 233 generates a control signal 211 that is proportionate to the magnitude of the detected difference or deviation (or ripple), in one or more embodiments.

In one or more embodiments, the comparator 233 generates a control signal that is opposite in signal value and/or sign to the detected difference or deviation, in one or more embodiments. The comparator 233 generates a control signal 211 corresponding to the ripple detected at the output common-mode. In one or more embodiments, the control signal 211 includes an analog voltage signal. In one or more embodiments, the control signal 211 is based on a deviation of output common-mode average from a target output.

Referring now to operation 207, and in some embodiments, the comparator 233 communicates the generated control signal to the predriver circuit. In one or more embodiments, the output of the comparator 233 is communicatively coupled to an input of the predriver circuit. In one or more embodiments, the output of the comparator 233 is electrically and/or physically coupled to an input of the predriver circuit. One or more amplifiers, buffers and/or inverters convey, repeat and/or amplify the control signal 211 from the comparator 233 to the input of the predriver circuit, in one or more embodiments.

In one or more embodiments, the comparator 233 drives, or is part of a feedback loop to adjust the relative pull-up versus pull-down strengths in the predriver circuit. The comparator 233 conveys or communicates the generated analog control voltage via the feedback loop or control loop, in one or more embodiments. In one or more embodiments, the comparator 233 provides or feedbacks the control signal to the predriver circuit. In one or more embodiments, the comparator 233 feeds or directs the control signal to the predriver circuit of the driver stage of the transmitter to control or adjust relative pull-up and pull-down strengths in the predriver.

Referring now to operation 209, and in some embodiments, the predriver circuit adjusts at least one of a pull-up strength and a pull-down strength in the predriver circuit using the generated control signal 221. In some embodiments, the predriver circuit adjusts a relative pull-up strength/pull-down strength in the predriver circuit using the generated control signal 221. The driver circuit generates the output based at least in part on the at least one of the pull-up strength and the pull-down strength adjusted using the received control signal 221.

In one or more embodiments, one or more switches connects the control signal 221 to a pull-up path and/or a pull-down path circuitry, e.g., to adjust the strength of the pull-up path and/or the pull-down path of the predriver 222. In one or more embodiments, the pull-up and/or a pull-down strength(s), or relative pull-up/pull-down strength, of a predriver 22 is controlled by means of the analog control signal 221 generated and/or communicated by the feedback loop.

In one or more embodiments, the control signal 221 includes an instruction or digital signal to adjust the output signal of the predriver 222. In one or more embodiments, the predriver circuit performs digital switching of at least one pull-up or pull-down device in the predriver circuit to adjust the strength of at least one of the pull-up path or the pull-down path in the predriver 222 circuit. For instance, FIG. 2E depicts embodiments of a system for output common-mode adjustment, using predriver circuits with pull-up and/or pull-down strength controllable by a control signal and/or at least one switch. In one or more embodiments, one or more switches introduces one or more of a control signal 211 (e.g., VCTRL), a VSS, a VDD value or level, to one or more portions of the predriver circuit to adjust the strength of a pull-up path and/or a pull-down path of the predriver circuit. For example, the one or more switches change the number of PMOS and/or NMOS devices in a pull-up and/or a pull-down path, and the pull-up and/or a pull-down strength of the predriver 222 is adjusted accordingly. Separately or in combination, one or more pull-up and/or a pull-down paths of the predriver 222 is adjustable using the control signal 211, in one or more embodiments. Therefore, in one or more embodiments, the predriver 222 employs a combination of analog and digital approaches, e.g., using digital switching of pull-up/pull-down devices.

By way of illustration, using a current mode transmitter, a pull-up path in an NMOS-type current mode cell (e.g., predriver circuit) is through a resistor while pull-down is through an NMOS device. The opposite is true of a PMOS-type current mode cell, in one or more embodiments. In one or more embodiments, the comparator 233 compares the output common-mode level against a target value to generate the control voltage 221. In one or more embodiments, the comparator 233 provides the control signal 211 to adjust the resistance of the current mode predriver 222. This adjustment is via analog control and/or performed digitally (e.g., with an intervening analog-to-digital converter to generate the digital controls), in one or more embodiments. The predriver circuit performs switching (e.g., digital switching) of at least one pull-up or pull-down device in the predriver circuit to adjust the strength of at least one of the pull-up path or the pull-down path in the predriver circuit. This adjustment balances, for example, the single-ended output eye, which minimizes deviation of the average transmitter output common-mode from a target output.

In one or more embodiments, the comparator 233, control signal 211 and/or the predriver 222 balance the single-ended output eye by adjusting signal slopes (e.g., rising and/or falling slope) in the predriver circuit to the driver stage. In one or more embodiments, the predriver circuit minimizes rms voltage at the output common-mode using the control signal 211. In one or more embodiments, the comparator 233, control signal 211 and/or the predriver pre-biases the signal input to the driver circuit. By pre-biasing signals provided by the predriver circuit to the corresponding driver stage 232, the control signal 211 indirectly controls or adjusts the output common mode signals of the driver stage 232, in one or more embodiments. In one or more embodiments, the control signal 211 indirectly compensates or adjusts for the mismatch in pull-up and pull-down strengths of the driver stage 232. In one or more embodiments, this compensation or pre-basing results in a reduced ripple or rms voltage at the output common-mode, as compared to a transmitter without the feedback loop. The single-ended output eye becomes more balanced thereby minimizing deviation of average output common-mode from the design target value, in one or more embodiments.

It should be noted that certain passages of this disclosure can reference terms such as “first” and “second” in connection with devices, signals, channels, etc., for purposes of identifying or differentiating one from another or from others. These terms are not intended to merely relate entities (e.g., a first signal and a second signal) temporally or according to a sequence, although in some cases, these entities can include such a relationship. Nor do these terms limit the number of possible entities (e.g., devices) that can operate within a system or environment.

It should be understood that the systems described above can provide multiple ones of any or each of those components and these components can be provided on either a standalone machine or, in some embodiments, on multiple machines in a distributed system. In addition, the systems and methods described above can be provided as one or more computer-readable programs or executable instructions embodied on or in one or more articles of manufacture. The article of manufacture can be a floppy disk, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

While the foregoing written description of the methods and systems enables one of ordinary skill to make and use various embodiments of these methods and systems, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A system for output common-mode adjustment, the system comprising:
a driver circuit of a complementary metal-oxide semiconductor (CMOS) transmitter, the driver circuit having an output common-mode;
a predriver circuit with an output in electrical communication with an input of the driver circuit; and
a comparator configured to generate a control signal using a difference between an average signal value of the output common-mode and a target value, and to adjust strength of at least one of a pull-up path or a pull-down path in the predriver circuit using the generated control signal.

2. The system of claim 1, wherein the driver circuit comprises a voltage-mode driver or a current mode driver.

3. The system of claim 1, wherein the pull-up path and the pull-down path are mismatched in strength.

4. The system of claim 1, wherein the average signal value of the output common-mode comprises a root mean square (rms) voltage value.

5. The system of claim 1, wherein the driver circuit or the CMOS transmitter is configured to operate at at least 10 gigabits per second.

6. The system of claim 1, wherein the control signal comprises an analog voltage signal.

7. The system of claim 1, wherein the predriver circuit is configured to perform digital switching of at least one pull-up or pull-down device in the predriver circuit to adjust the strength of the at least one of the pull-up path or the pull-down path in the predriver circuit.

8. The system of claim 1, wherein the predriver circuit is configured to minimize root mean square (rms) voltage at the output common-mode using the control signal.

9. A method for output common-mode adjustment, the method comprising:
generating, by a predriver circuit, an input signal to a driver circuit of a complementary metal-oxide semiconductor (CMOS) transmitter, the driver circuit having an output common-mode;
generating, by a comparator, a control signal using a difference between an average signal value of the output common-mode and a target value; and
adjusting by the predriver circuit, strength of at least one of a pull-up path or a pull-down path in the predriver circuit using the generated control signal.

10. The method of claim 9, wherein the driver circuit comprises a voltage-mode driver or a current mode driver.

11. The method of claim 9, wherein the average signal value of the output common-mode comprises a root mean square (rms) voltage value.

12. The method of claim 9, further comprising operating, by the driver circuit, at at least 10 gigabits per second.

13. The method of claim 9, further comprising performing, by the predriver circuit, switching of at least one pull-up or pull-down device in the predriver circuit to adjust the strength of the at least one of the pull-up path or the pull-down path in the predriver circuit.

14. The method of claim 9, further comprising minimizing root mean square (rms) voltage at the output common-mode using the control signal.

15. A system for output common-mode adjustment, the system comprising:
a predriver comprising circuitry configured to:
generate an input signal to a driver circuit of a complementary metal-oxide semiconductor (CMOS) transmitter, the driver circuit having an output common-mode;
receive a control signal indicative of a difference between an average signal value of the output common-mode and a target value; and
adjust strength of at least one of a pull-up path or a pull-down path in the predriver circuit using the received control signal, wherein the output to the driver circuit is generated based at least in part on the strength of the at least one of the pull-up path or the pull-down path adjusted using the received control signal.

16. The system of claim 15, wherein the driver circuit comprises a voltage-mode driver or a current mode driver.

17. The system of claim 15, wherein the average signal value of the output common-mode comprises a root mean square (rms) voltage value.

18. The system of claim 15, wherein the predriver circuit is configured to operate at at least 10 gigabits per second.

19. The system of claim 15, wherein the predriver circuit is configured to perform switching of at least one pull-up or pull-down device in the predriver circuit to adjust the strength of the at least one of the pull-up path or the pull-down path in the predriver circuit.

20. The system of claim 15, wherein the predriver circuit is configured to minimize root mean square (rms) voltage at the output common-mode using the control signal.
